(19) United States
(12) Patent Application Publication
(10) Pub. No.: US 2011/0225103 A1
(43) Pub. Date: Sep. 15, 2011

(54) EFFICIENCY OF COMPUTER MODELING AND ANALYSIS OF COMPLEX PROCESSES

(75) Inventors: Michael Paul Clarke, Ellenbrook (AU); Parijat Dube, Yorktown Heights, NY (US); Eitan Daniel Farchi, Pardes Hana (IL); Thanh V. Lam, Poughkeepsie, NY (US); Gregory Fraser Russell, Yorktown Heights, NY (US); Devaki Shah, North Wales, PA (US)

(73) Assignee: International Business Machines Corporation, Armonk, NY (US)

(21) Appl. No.: 12/720,018

(22) Filed: Mar. 9, 2010

(51) Int. Cl. G06Q 10/00; G06Q 50/00; G06N 5/02

(52) U.S. Cl. 705/347; 706/52

(57) ABSTRACT

A system and method for constructing and analyzing a graphical representation of a complex process comprises steps and means for receiving input of content related to the complex process; processing said input to identify entities and actions instrumental in the execution of the complex process; constructing a graphical representation of the process as a network comprising first nodes, representing decision points, second nodes representing primary stakeholders and actions providing direct input to decision making points, and leaves representing secondary stakeholders providing indirect input to decision making points; and applying at least one analytic approach for evaluating the decision points of the graphical representation of the process.

### FIELD OF THE INVENTION

The present invention relates generally to using computers to model and simulate complex processes, specifically with an aim to evaluating the effects resulting from the interaction of multiple separate decisions made by different subsets of stakeholders in the overall process.

### BACKGROUND OF THE INVENTION

Almost all processes are driven by multiple decisions taken at different times by different people within the organizations involved, sometimes revisited and revised and rarely taken with a comprehensive ‘big picture’ view in mind. Decisions tend to favor the needs of the most influential stakeholders present, even if those decisions detract from the goals of the overall process. This is a well known phenomenon referred to as “suboptimization” which leads to inefficiencies and a loss of direction in the execution of the overall process.

Typically, with a complex process such as software development, the effects of suboptimization are not considered at all. It is desirable to model the behavior and simulate the process on a computer to, firstly, demonstrate the effects of suboptimization; secondly, predict the effects of certain decisions upon the process; and thirdly, find one or more optimal “solutions” to the overall process that will strike an acceptable balance among the suboptimizations of all of the decisions involved (and thus address the requirements of as many of the stakeholders as possible).

Prior approaches to modeling processes for software development and other compound processes have used decision trees. Decision trees generally provide a process mapping with the effect of different decisions being binary one way flows. Such mapping is not comprehensive enough to encompass all of the inputs to a decision point when different stakeholders may influence decisions at different levels. Complex processes have multiple decision points with multiple stakeholders and multiple dependent decision points. Moreover, the dynamics of these complex processes over time are not a simple waterfall from the first decision to the last. The output of later decisions and process steps can result in the revisiting and revision of decisions that were taken some time prior and which have already been fed on into other parts of the process. For example, if a design step concludes that the cost to implement a particular software feature is much higher than originally thought, it can cause revisiting of the decision about which software features to include in the software release, resulting in a different set of software features being selected (e.g., excluding an expensive one or replacing it with one or more simpler ones). Naturally this revision of the decision happens several weeks after the original decision was made at a point in time at which the development process for the other features is already well underway, thus changing the criteria for making the decision. This time-variant decision making is very hard to address by any manual modeling process.

What is needed is a mechanism by which is can be easily viewed within an organization and by which the predicted effects of changes within the process can be readily assessed. For example, adding a step where the software designer directly talks with the customers who requested a feature could be expected to improve the quality of the information (and thus the relevance of the resultant software product), while replacing a person with 10 years experience with the product with someone who has never used it could be expected to cause further information degradation.

Thus, there is a need in the art, and it is an object of the present invention to provide, a method and apparatus by which a complex process can be decomposed into its actors and decision points as well as their dependencies.

It is a further object of the invention to provide a method by which complex process entities and the relationships between them can be instantiated within a computer program and a simulation of the complex process can be executed, thereby allowing for viewing of the resulting network, analysis of information propagation through the network, identification of some of the optimal solutions to the network of decisions, and analysis of the impact that a given change or set of changes could be expected to have upon the overall execution of the complex process and the output that it produces.

### SUMMARY OF THE INVENTION

The present invention provides a system and method for constructing and analyzing a graphical representation of a complex process comprising steps and means for receiving input of content related to the complex process; processing said input to identify entities and actions instrumental in the execution of the complex process; constructing a graphical representation of the process as a network comprising first nodes, representing decision points, second nodes representing primary stakeholders and actions providing direct input to decision making points, and leaves representing secondary stakeholders providing indirect input to decision making points; and applying at least one analytic approach for evaluating the decision points of the graphical representation of the process.

### BRIEF DESCRIPTION OF THE DRAWINGS

A more particular description of the invention is provided below with reference to the embodiments illustrated in the appended drawings. It is to be noted, however, that the appended drawings illustrate only typical embodiments of the invention and are therefore not to be considered limiting of its scope, for the invention may admit to other equally effective embodiments.

FIG. 1 is a diagram comprising decision nodes having relationships to stakeholders and being connected by edges representing interactions between nodes in accordance with the present invention;

FIG. 2 is a flow chart illustrating one embodiment of a method for implementing the present invention; and

FIG. 3 is a diagram of a system in which the present invention may be implemented.

### DETAILED DESCRIPTION OF THE INVENTION

The present invention seeks to decompose the modeling of a compound process, such as a software program being developed, into a plurality of different decision points which are potentially solvable. A decision point is a point in time within the process lifecycle where conflicts between a set of stakeholders need to be resolved. A network is a qualitative entity relationship diagram that relates the different decision points. The diagram provides insight into an organization's process and conflict resolution structure.

Network modeling takes a holistic approach to analyzing the process flow and execution. A high level process normally contains a number of low level processes (also referred to as “sub-processes”), which may in turn be composed of even lower level processes. The sub-processes are linked not only by various artifacts, such as specifications and designs, but also by the people that execute them. The goal of the network modeling is to chart the flows between the sub-processes at the decision points, via the artifacts and the people involved. Each sub-process should be classified as either a transformation (taking one thing and turning it into another) or as a decision (choosing between alternatives). While the classification does not directly affect the flow of sub-processes, it does affect the selection of techniques for analyzing and improving each class of process.

Each decision point in the process flow is modeled as a game. Solving the game resolves the stakeholders' conflicts at a specific decision point. The actual game used in a decision point differs depending on the nature of the conflict and may reflect things like the completeness of information at the decision point or whether the conflict resolution is short term or long term. At a decision point, each stakeholder has different concerns and an individual point of view of the process efficiency. The preferences and concerns of a stakeholder determine the measures or model parameters that each stakeholder will view to be most important. While soliciting input directly from stakeholders is a way of gathering stakeholder preferences, such information may also be automatically obtained, via analysis of historical data and analysis of stakeholders' job descriptions and performance evaluation benchmarks.

The network of games captures the entire conflict resolution process leading to the process or software product. Once the process has been constructed as a network of games, a simulator is developed for the computer to execute the simulator to analyze the process. For the software example, each simulator may be used to assist in creating software products that will satisfy the stakeholders and eliminate inefficiencies in the requirement engineering process.

The first stage in the modeling and development of a decision process is to generate a qualitative entity/relationship diagram, which will give insight into the structure of the organization and provide a way of understanding the data flows and recognizing which decision points involve stakeholders with conflicting set of preferences and hence can be modeled as games. Next a network of stakeholders that influence the respective decision points is constructed. The initial construction of stakeholder relationships is according to the entity's processes, however it should be recognized that there are other networks (e.g., social, reporting, etc.) within which the stakeholder nodes may be participating and which may need to be represented in the model. The usage of a network visualization tool, such as Guess*, is recommended.

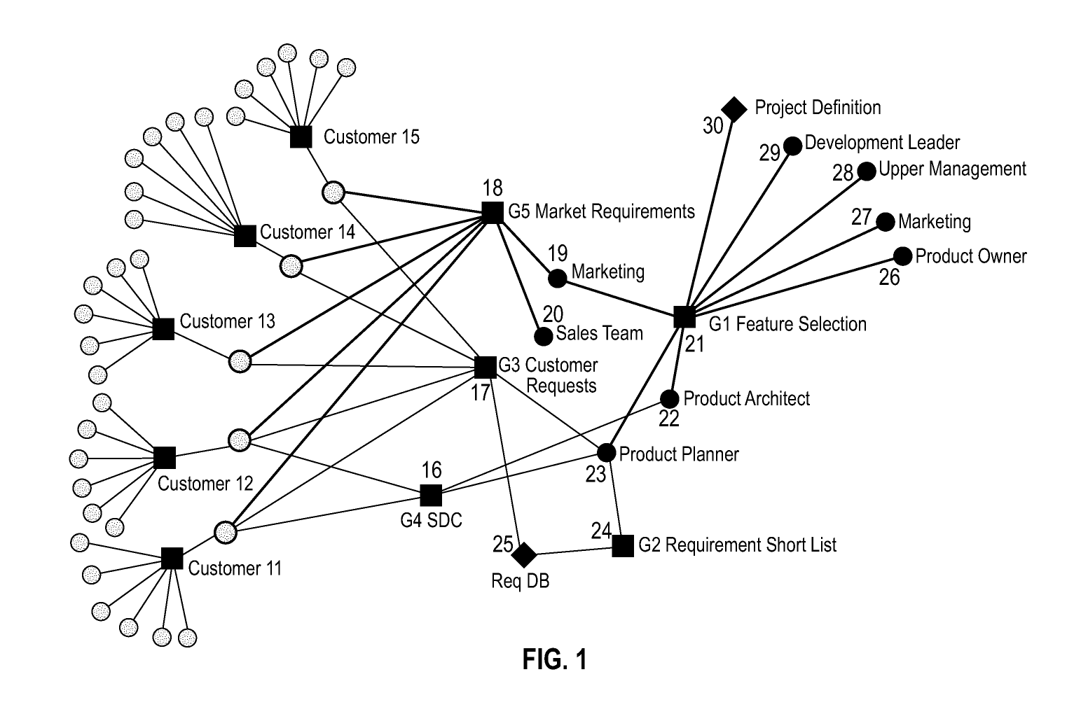

A graphical model, FIG. 1, illustrates multiple different decision points and their dependencies, capturing dependencies between different decision points and the direct or indirect influence of stakeholders on the decision points in the process. The approach captures conflicts between the different stakeholders and dependencies between different decision points in the process and provides a visual representation of the compound process and its dynamics. Once the graphical models have been realized, analytic tools, such as game theory, can be applied to simulate the decision making and/or processing to evaluate the models and identify any problems (e.g., dead ends, potential deadlocks, conflicts, etc.). As noted above, the inventive method can be applied for modeling and analyzing any compound process. As will be apparent to one having skill in the relevant art, the modeling process may be implemented in the aforementioned two stages, a first stage to model the process and a second stage to analyze the model, or as a series of iterations to identify and position the relevant entities and actions. Further, each decision point can be analyzed in isolation and the effects of an outcome at a decision point on other dependent decision points can be captured by defining suitable interfaces connecting the decision points. An interface in this context is a set of statistical measures which are some functions of the outcome of the game at a decision point. These statistical measures act as input to games at other dependent decision points and may affect the games at the dependent decision points.

It should be noted that the shape and extent of the network, including the participation of specific stakeholders is expected to vary over time. Decisions taken early on during the project determine, to a large, extent, the shape and evolution of the network over time. A project which frequently revisits its early decisions will have a network that frequently changes shape and within which stakeholders can change roles or be added or removed. The ability to predict the effects of revising an early decision upon the network is of significant value. This function could, for example, be linked to a project management tool such as Microsoft Project™.

For ease of description hereinafter, the invention will be described with reference to a specific implementation for a software development process. It is to be understood that the invention is not limited to use only in the software development process. Moreover, the ensuing description refers to the modeling of processes as a network of games and the application of game theory for simulating the decision making and processing; however, the invention is not limited to use of game theory. Game theory mathematically captures behavior in so-called gaming situations, wherein an individual's success in making choices depends on the choices of others. Other analytical tools, such as multi-criteria optimization, may alternatively be applied to test the modeled processes.

In the software development process, features of the product and the respective quality attributes of those product features are decided upon during development. As noted above, multiple stakeholders may have influence over which features are included and what should be the attributes of those features. Moreover, as decisions are made for one software feature, those decisions will have ramifications for subsequent (or previous) decisions regarding additional features and attributes. Under the present invention, the software development decision process is modeled as a network of games. An individual game resolves the conflicts of the stakeholders involved at specific decision points in the software development process. The games interface with each other through stakeholders and artifacts that are common to multiple games. This means that the same stakeholder may be playing in multiple games simultaneously or sequentially, acting as a conduit for decisions and information between the games. Stakeholders are expected to adjust their position in one game as a result of a decisions reached in other games. For example, requirements which are a result of one decision point serve as input to the next design decision point. In this way, the entire software development process is captured as a network of interconnected games.

FIG. 1 illustrates a diagram comprising several games. Each game has a ‘game’ node at its center that represents a decision or an activity as described below. Edges then connect the game nodes to the people and artifacts that play in that game. These ‘player’ nodes represent the stakeholders who directly participate in that game and any artifacts that are inputs to or outputs from the game (an artifact may be both output of one game and input to another and its status as input or output may change over time). Artifacts are typically records of decisions or the output of non-decision activities. A game is therefore a decision or an activity and the set of people and artifacts that participate in it. The network of games emerges from the interconnection of multiple games by the people and the artifacts that they have in common.

In the FIG. 1 diagram, the decision nodes correspond directly to game nodes (appearing as squares), with their relationships going to the primary player/stakeholders (appearing as dark-centered circles). There is a set of secondary games associated with each game, as the secondary players (depicted with light-centered circles representing those not participating directly in the game) seek to influence the primary players. Essentially, the result is a network of games.

For the software development example, node 21 represents the first “game” denoted as G1 for Feature Selection. Node 24 is denoted as Game 2 representing the requirements short list for the software. Node 17 represents the customer requests, denoted as Game 3. Node 16 represents the SDC (Software Development Council), characterized as Game 4 in which some of the customers are participating to help understand the challenges facing them in using the software. Node 18 shows Game 5 representing the Marketing Requirements. All of the so-called game nodes are decision making points at which some requirements for the software are determined (or at least recommended). Accordingly, each game has an output which is a solution to the game at that particular decision point. Typically a game will have multiple possible solutions—the players will choose one and produce the necessary artifacts to document it. The aim of the simulation software is to find a set of solutions to all of the games involved that gives the best overall result at the end of the process, as opposed to the best results at different points for some of the individual stakeholders. The action nodes are shown as squares in FIG. 1.

A plurality of entity nodes, or leaves, shown as circles, are illustrated, each connected to one or more of the decision making point nodes. The leaves represent the stakeholders participating in the decisions at the decision making points. For Game 1 of Feature Selection, the leaves or stakeholders are the Development Leader 29, Upper Management 28, Forecasting 27 and the Product Owner 26. The original Project definition, shown as a diamond-shaped node at 30, is an input to the Feature Selection game. This is an artifact—typically a document that records the output of another game or an earlier iteration of the game that produced it. In addition, the Product Architect will have input into the Feature Selection game, as represented at leaf 22, as will the Product Planner represented at leaf 23. Finally, Marketing will be a stakeholder in the Feature Selection, as shown by the connection from leaf 19 to the Feature Selection game node 21.

All of the stakeholders referenced above have some impact on the Feature Selection game. However, some of those stakeholders also have a stake in different aspects (i.e., games) of the software development process. For example, Game 5 of defining the Market Requirements at node 18 receives input from multiple customer stakeholders, leaves 11-15, likely in the form of input to marketing surveys. A Sales Team leaf, at 20, will also provide input for identifying Market Requirements. The Marketing Department, at leaf 19, is also a stakeholder in the Marketing Requirements game, and will necessarily use the results of Game 5 as a stakeholder in the Feature Selection Game.

Customers 11-15 may additionally provide input to Game 3 at node 17, which is the node representing the handling of customer requests. The Customer Request game will also have input from the Product Planner, at leaf 23, who is in turn a stakeholder who will weigh in on the Feature Selection Game, being responsible for representing the results of the Customer Request game in the Feature Selection game. In essence he is acting as a Proxy for the customers—but after having applied his skills to aggregate, prioritize and summarize the customers' inputs to produce the Requirements Short list.

A more limited number of Customers, shown as leaves 11 and 12, may also have input to the SDC game, and will have had an opportunity to talk directly with the Product Planners and Product Architects. The SDC Game at node 16 receives input from the selected customers as well as from the Product Planner and the Product Architect. The latter two are then responsible for representing the customers who participated in the SDC Game in the Feature Selection game. The information flow in the SDC game is bi-directional—customers learn the results of recent Feature Selection games and give feedback which may be used to revise those results in a later iteration of the Feature Selection game for those products, and they provide information about new and previously unaddressed requirements that become input into later Feature Selection games for other products.

The Product Planner, at leaf 23, has access to a Requirements Database, shown as a diamond-shaped node at 25, which contains the aggregated customer requirement that were input into Game 3 and which is the primary input into Game 2 Requirements Short List (which is more of an activity rather than a decision, as the game only has a single player). The Product Planner brings the results of the Requirements Short List game as input to the Feature Selection Game, along with the results of the SDC Game and the Customer Requests Game.

It is to be noted that multiple stakeholders may be participating in the same games represented at multiple decision making points, for example, the Product Planner and the Product Architect both participate in the SDC game at node 16 and the Feature Selection Game at node 21. However, each stakeholder has a unique perspective on the software development process and each has a different amount of influence on the represented game based on their expertise and the respective weights of their expertise. As noted above, the outcome of the decision making at one point, for example at Game 5 where the Market Requirements are refined, will influence the outcome at another decision making point, in this case the Feature Selection.

By automatically constructing a model of the multiple decision process as shown in FIG. 1, the inventive system and method provide a formal way to view and analyze the complex process including the stakeholders involved at the different decision points. Such a graphical representation of the complex process and its dynamics has value even before simulation analytics are applied. For example, the flow and interconnectedness of the process can be automatically reviewed to identify participants who act as interfaces between various sub-processes and who may become bottlenecks in the overall process. The graphical representation can be evaluated to establish, roughly, how long each process in the network will take and to provide a rough estimate of the total time for a project to progress between any two points on the graph. Critical paths can be determined to identify areas to be analyzed for potential throughput improvement. Influence can be estimated by using some simple network propagation algorithms. The strength of the network can be estimated. For example, at points where there is only a single player connecting two sub-processes, those points represents points of weakness in the network, since the overall process cannot advance if that single player is unavailable. Overly-subscribed sub-processes can be identified as ones that involve more people than could reasonably be expected to be accommodated at the decision point.

Applying analytics to the model allows identification of inefficient sub-processes or decision flows within the process, which can then be avoided to improve the overall efficiency of the process. The network of games is used to identify inefficiencies in the software development decision process and to test corrections and improvements to the decision process. Feedback is obtained by the model and, once a change is suggested, the network is recalculated to reassess the impact of the change on the outcome and on the quality of the decision process. The collecting of feedback, network recalculation and reassessment steps are repeated until an optimal process is identified. Changes to the network based on feedback may include changing stakeholder influence, providing alternate compensation to stakeholders, changing the structure of the decision process, for example by deleting or adding communication links in the network, and changing the way that different stages of the decision process interact, for example by strengthening or weakening the influence of the results of one game on the next game.

Consider how a product feature might arise under the network depicted in FIG. 1. The need for the requirement starts with the customers, some of whom are encountering problems using the software as-is. Most of these customers, 11-15, will submit a request to the software company for the company to do something about the problem (Game 3: Customer Requests at node 17). The Product Planner at 23 will add their requests to the products request database at 25, maintaining duplicate counts. A couple of the customers, shown as 11 and 12, may additionally be participating in the SDC (Game 4) at node 16, in which case they will pass their concerns on to the Product Planner at 23 and the Product Architect at 22. The Product Planner will use his knowledge from the SDC to aid his selection of features to propose to the management committee, entities 26-29 in the Feature Selection Game 1 at node 21. When the Feature Selection meeting occurs (i.e., Game 1), both the Product Architect and the Product Planner will speak in favor of implementing some feature to address the customers' problems, presumably leading to that feature becoming a part of the development plan.

In the preferred embodiment each game in the network of games is implemented as a cooperative game of features while using the Shapley Value to solve the game. As a result, each game has a single solution which makes it possible to calculate the network of games results given the results of each individual game. The edges of the network of games are defined as dummy players used to represent the result of the current game for the following game. The dummy player acts as a bridge between two games and provides constraints, preferences and rules for playing the next game.

A concrete example of a game node that demonstrates the conflict resolution process using the Shapely value is given below. The Shapely Value is used to model the influence of a stakeholder on the adopting of a software feature. Thus, a formal relation is obtained between the assumptions on the bargaining structure, the interests of the stakeholders and the influence of stakeholders on the adopting of a software feature. Generalized models of this type may make trade-offs in the construction of the bargaining structure that leads to choosing software features explicitly.

A cooperative game of N={1, . . . , n] stakeholders is defined. There are k software features that are being considered. A stakeholder is assumed to have a set of core values. As a result of the stakeholder core values, there are features the stakeholder supports and there are features the stakeholder opposes or is indifferent about. Thus, for each stakeholder, i in N, there is given a vector pᵢ in {for, against, indifference}̂k expressing the stakeholder's core values. For example, if there are 3 features, k=3, then p₁=(for, against, indifference) means that player one is for feature one, against feature two and indifferent about feature three. To complete the definition of the game, what must be defined is what each coalition of stakeholders can obtain by themselves. For example, consider a coalition S of two stakeholders. The value of the coalition, V(S), is zero if there is some feature that one stakeholder in the coalition supports and another stakeholder in the coalition is against. Otherwise, the value of the coalition is one (other options exist, e.g., the number of agreements the coalition has). The game solution is the Shapely Value assigning an index of power for each stakeholder that represents its influence of the feature choice.

Consider the following example. N={1, 2, 3}, k=3, and p₁=(for, against, against), p₂=(against, for, indifferent), p₃=(against, indifferent, for). In this case, V(1)=V(2)=V(3)=1, V(1,2)=0, V(1, 3)=0, V(2, 3)=1, V(1, 2, 3)=0. Next, the index of power of the players is calculated. Players 2 and 3 are symmetrical and have the same index of power. The index of power of one is calculated for one of them (player 2). Using the order in which the people entered the room as a criterion for commencing the analysis (see Shapely's value interpretation, A Course in Game Theory by Osborne, M. J. and Rubinstein, A., MIT Press (1994), chapters 13, 14 and 15), the contribution of player 2 is calculated in each case and then averaged. Each order is given the same probability of ⅙.

| | |
|---|---|
| 123 | V(12) − V(1) = −1 |
| 132 | V(123) − V(13) = 0 |
| 213 | V(2) = 1 |
| 231 | V(2) = 1 |
| 312 | V(123) − (13) = 0 |
| 321 | V(23) − V(3) = 1 |

Thus, the index of power of players two and three are 2/6=⅓. Next, player 1 is considered, with the following results.

| | |
|---|---|
| 123 | V(1) = 1 |
| 132 | V(1) = 1 |
| 213 | V(12) − V(2) = −1 |
| 231 | V(123) − V(23) = −1 |
| 312 | V(13) − V(3) = −1 |
| 321 | V(123) − V(23) = −1 |

Thus, the index of power of player one − 2/6=−⅓.

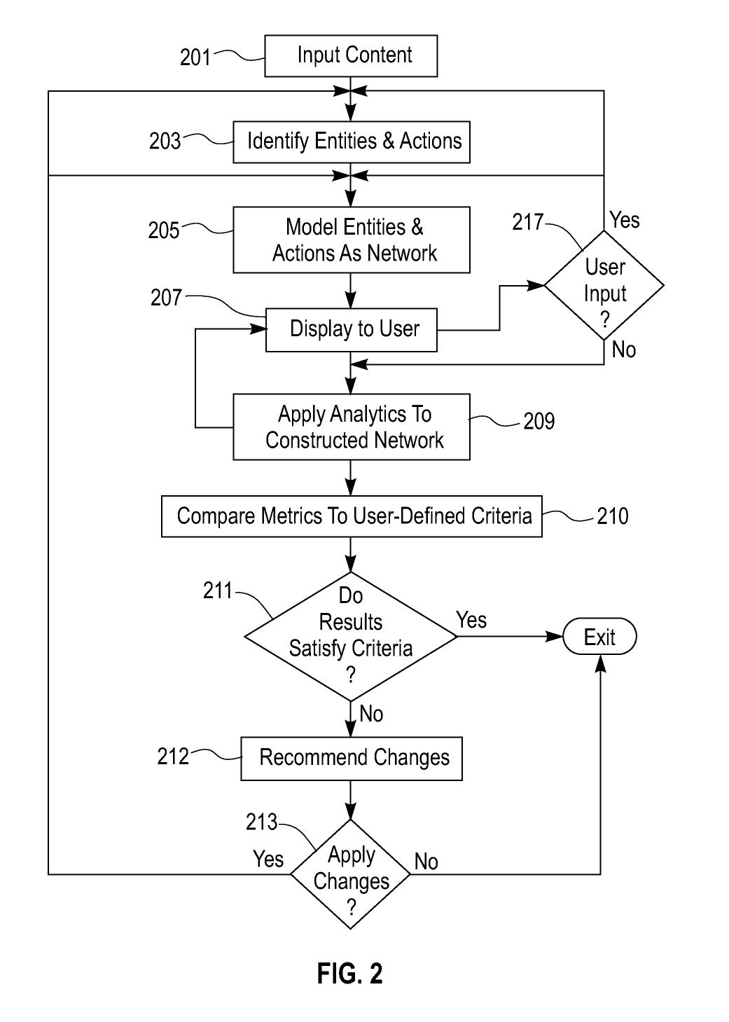

Based on the calculated indexes of power, it may be concluded that a suitable decision cannot be reached (i.e, non-convergence) or that the process will not perform well against the pre-selected metrics. In such an instance, where the results do not satisfy the criteria for evaluation, changes may be recommended to the user/developer or automatically applied. Changes may include deleting entities, changing the index of power for one or more stakeholder entities, or altering actions to re-construct the network, after which the model would again be run and evaluated against the selected metrics, as further detailed with reference to FIG. 2 below

FIG. 2 is a flow chart illustrating one embodiment of a method for a computer with at least one processing device to implement the present invention, again using software development as the example of a complex process being modeled and analyzed. The process flow begins at step 201 with input of content related to the software to be modeled. If the software to be modeled already exists and is being upgraded, there may be SDP historical data, use cases and customer feedback, along with the original software definition and features available as content to be input. For software to be developed anew, a project definition, best practices, and feedback on similar products may be input.

At step 203, a process, for example statistical techniques or data mining, is applied with respect to the input content in order to derive or identify entities and actions influencing the software to be developed. At step 205, the identified entities and actions are mapped as a network. As described above, the network creation may be implemented in two stages, one of creating a qualitative entity-relationship diagram having, for example, decision making points, major stakeholders and dependencies or interactions, followed by the stage two construction of a network of additional, secondary stakeholders. Decision choices (e.g., from previous decision points) and decision rules (i.e., rules outlining or quantifying how decisions made at one decision point affect decisions at a next decision point) may also be included as input (i.e., actions) to the games and the network of games.

An optional step, not shown, is to refine the network by quantifying the relative influence, or weight, a stakeholder or stakeholder's concern should bring to bear on the decision point. One approach to such weighting is to seek feedback from each stakeholder, requesting that they identify and rank their concerns for a particular decision. Once the ranked concerns have been received from all stakeholders for a particular decision, a collected set of ranked concerns from all stakeholders can be numerically analyzed to produce a preferred set of concerns for that decision point. Another approach, as alluded to above, is to automatically identify stakeholder interests based on historical data or analysis of stakeholders' job descriptions and performance evaluation benchmarks.

The constructed network structure includes nodes, edges and leaves as depicted in FIG. 1. At this stage in the process flow, the constructed network may be displayed to the user, at step 207, for user input at 217. Here the “user” may be the developer or a group of entities charged with the task of overseeing the development process and analysis. If there is no user input, the method will proceed to step 209 to apply analytics to the constructed network. The analytics will “run the model” to simulate the process and measure various user-defined metrics by which the results can be evaluated. For example, the user/developer may indicate that maximizing speed and minimizing cost are critical metrics against which various versions of the games should be evaluated.

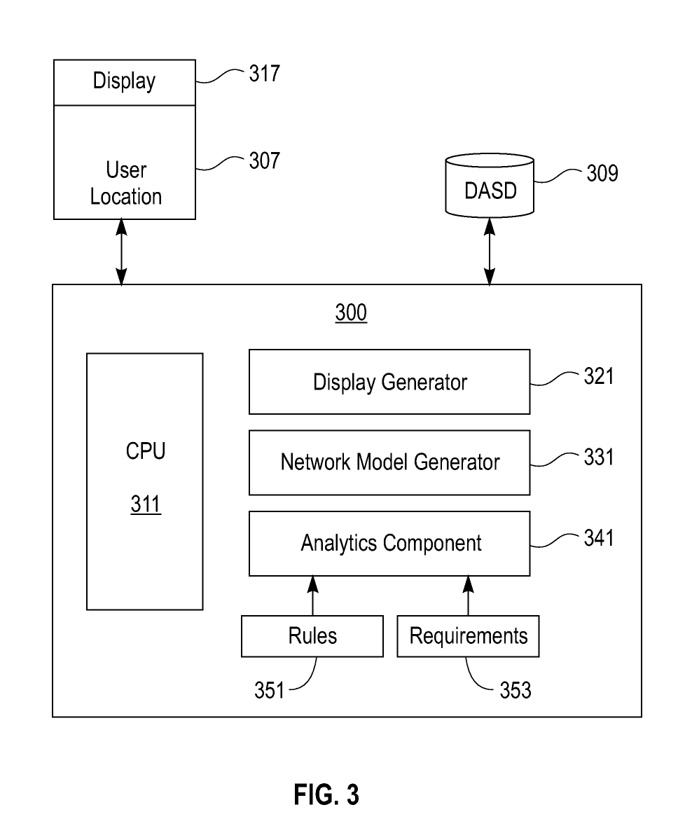

To run the simulation, each game in the network needs associating with a piece of computer code, labeled in FIG. 3 as the Analytics Component, that will “play” the game it represents. Such parameters would be inputs into the Analytics Component, possibly being held as attributes of the game node itself. Attributes on the player and artifact nodes describing them to the game playing software would also be provided. It is to be noted that participation of a player in a game would, literally, change the player, updating its attributes and thus influencing its participation in later games. At step 209, the method will apply one or more analysis techniques (e.g., Shapley value, stable set, core and kernel) to solve the network of games.

In the preferred embodiment of applying a Shapely value approach, Shapely solves a single game, but the game becomes unsolved as soon as any of the players gets changed as a result of participating in any other game. The execution cycle will, consequently be non-linear, with games basically nominating themselves to be played and replayed, if appropriate. It may be desirable to implement some time-based limits, such as “no replay more than once every simulated week”. The game playing or simulation ends (i.e., a solution has been found) when all of the games have stabilized on their current results (i.e., the game was replayed and it came to the same answer as the previous time it had been played). This is a relaxation method, similar to finite element analysis used by the IBM Related Individual Based Modeling Engine. The game playing or simulation may also pause if it finds that it needs additional human network modeling input, shown as the loop from 209 to 207 to 217 and back to 209, to support a set of decisions the modeler did not originally envision. At the end of the run, the results include the expected production time and quality of the final product and the feature list for the network model. The results may be compared to metrics which have been pre-selected by the user/developer at step 210. If the results compare favorably, the method may exit.

In such an instance where the results do not satisfy the criteria for evaluation, changes may be recommended to the user/developer or may be automatically applied. If there is user input at this stage, the user may suggest changes to the entities or actions that have been identified or changes to the network as modeled, with that feedback causing the method to re-execute steps 203 and/or 205 to construct a new network of games for display to the user. Once a completed network has been generated, the method will apply one or more analysis techniques at step 209 to solve the game(s) and evaluate the outcomes of the multiple prospective solutions of the networked games. Problems such as infinite loops, unsolvable games, etc. may be recognized through the analysis. If problems have been identified, the method may recommend changes at 212 and, with optional user authorization of the changes (not shown), apply the changes, at step 213. Alternatively, the system and method may automatically implement changes, including changes to the entities or actions that have been identified or changes to the network as modeled, with that feedback causing the method to re-execute steps 203 and/or 205 to construct a new network of games and reiterate the process.

FIG. 3 is a diagram of a system in which the present invention may be implemented. At computer processing location 300, which may or may not be integrated at a user input location, at least one processing device, shown as CPU 311, operates to execute a Display Generation component 321, a Network Model Generator 331, such as an emergent network simulation component detailed in U.S. Pat. No. 6,789,101, the contents of which are incorporated by reference herein, and an Analytics Component 341, such as a game playing software for running the model, evaluating the performance of the model against various metrics, and possibly recommending changes to the process to improve the performance thereof. The Network Model Generator, executing on the processor, operates to receive the input content, from a user at device 307 and one or more remote or local storage devices 309, and to construct the network of games. The constructed network of games may be provided to the Display Generation component 321 for display to a user at user device display 317. The constructed network of games may also be provided to the Analytics Component 341, executing on the processor, for application of games simulation to analyze the network of games. Rules, illustratively stored at 351, and Requirements, shown stored at 353, are additional inputs to the game playing Analytics Component 341. As noted above, messages may be sent to the user device 307 regarding the measured metrics and/or problems detected in the network of games. The generated display of the network of games may also be provided to local or remote storage, for example the illustrated DASD 309.

The methodologies of embodiments of the invention may be particularly well-suited for use in an electronic device or alternative system. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in one or more computer readable medium(s) having computer readable program code embodied thereon.

Any combination of one or more computer usable or computer readable medium(s) may be utilized. The computer-usable or computer-readable medium may be a computer readable signal medium or a computer readable storage medium. A computer readable storage medium may be, for example but not limited to, an electronic, magnetic, optical, electromagnetic, infrared, or semiconductor system, apparatus, device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus or device.

A computer readable signal medium may include a propagated data signal with computer readable program code embodied therein, for example, in baseband or as a part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices. The term “memory” as used herein is intended to include memory and other computer-readable media associated with a processor or CPU, such as, for example, random access memory (RAM), read only memory (ROM), fixed storage media (e.g., a hard drive), removable storage media (e.g., a diskette), flash memory, etc. Furthermore, the term “I/O circuitry” as used herein is intended to include, for example, one or more input devices (e.g., keyboard, mouse, etc.) for entering data to the processor, and/or one or more output devices (e.g., printer, monitor, etc.) for presenting the results associated with the processor.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although illustrative embodiments of the present invention have been described herein with reference to the accompanying drawings, it is to be understood that the invention is not limited to those precise embodiments, and that various other changes and modifications may be made therein by one skilled in the art without departing from the scope of the appended claims.

1. An automated method for a computer processing device to perform a method for modeling and analyzing a compound process having multiple dependencies, the method comprising the steps of:
decomposing the process into sub-processes representing various decision points;
constructing a graphical representation of the process by providing nodes for each of a plurality of decision points and defining interfaces capturing dependencies between decision points;
identifying an influence of at least one primary stakeholder for each decision point;
depicting the influence as at least one dependency to each decision point on the graphical representation; and
displaying the graphical representation.

2. The method of claim 1, further comprising a step of applying at least one analytic approach for evaluating the decision points of the graphical representation of the process.

3. The method of claim 4, wherein the method further comprises generating results of said evaluating for comparison against one or more predefined process performance metrics and displaying the results to at least one user.

4. The method of claim 2 wherein the graphical representation comprises a network of games and wherein said applying at least one analytic approach comprises using at least one cooperative game theory solution concept to study the decision points in the process.

5. The method of claim 4 wherein the at least one cooperative game theory approach comprises at least one of Shapely value, stable set, core and kernel approaches.

6. The method of claim 2 further comprising calculating relative weights as a measure of bargaining power of the more than one primary stakeholder, whereby said step of applying at least one analytic approach for evaluating the decision points of the graphical representation of the process uses the relative weights.

7. The method of claim 1 further comprising identifying and graphically representing a subnetwork of secondary stakeholders as dependencies to said plurality of decision points.

8. The method of claim 1 further comprising receiving feedback from the at least one user.

9. The method of claim 8 further comprising updating the graphical representation based on feedback to provide an updated graphical representation.

10. The method of claim 9 further comprising applying at least one analytic approach to evaluate the updated graphical representation of the process.

11. A method for constructing and analyzing a graphical representation of a complex process comprising steps of:
receiving input of content related to the complex process;
processing the input to identify entities and actions instrumental in the execution of the complex process;
constructing a graphical representation of the process as a network comprising first nodes that represent decision points, second nodes that represent primary stakeholders and actions providing direct input to decision making points, and leaves representing secondary stakeholders providing indirect input to decision making points; and
applying at least one analytic approach for evaluating the decision points of the graphical representation of the process.

12. The method of claim 11 further comprising comparing results of said evaluating to at least one threshold for at least one predefined metric.

13. The method of claim 12 further comprising the steps of:
when the results have a first predetermined relationship to the at least one threshold for at least one predefined metric,
determining that the graphical representation of the process illustrates the optimal process;
when said results have a second predetermined relationship to the at least one threshold for at least one predefined metric,
updating the graphical representation to produce an updated graphical representation;
applying at least one analytic approach for evaluating the decision points of the updated graphical representation; and
comparing results of said evaluating of the updated graphical representation to at least one threshold for at least one predefined metric.

14. The method of claim 13 further comprising determining that the graphical representation of the process illustrates the optimal process when the results have a first predetermined relationship to the at least one threshold for at least one predefined metric.

15. A system for constructing and analyzing a graphical representation of a complex process comprising:
at least one processing device for executing components;
at least one communication component for receiving input of content related to the complex process;
a network model generator component for constructing a graphical representation of the process as a network comprising first nodes, representing decision points, second nodes representing primary stakeholders and actions providing direct input to decision making points, and leaves representing secondary stakeholders providing indirect input to decision making points; and
an analytics component for applying at least one analytic approach for evaluating the decision points of the graphical representation of the process.

16. The system of claim 15 further comprising at least one storage location for storing at least one of content related to the complex process and a graphical representation of the process.

17. The system of claim 15 wherein said at least one communication component is adapted to receive user feedback to cause the network model generator to generate an updated graphical representation.

18. A program storage device readable by a machine and storing computer instructions for the machine to implement a method for constructing and analyzing a graphical representation of a complex process, the method comprising steps of:
receiving input of content related to the complex process;
processing the input to identify entities and actions instrumental in the execution of the complex process;
constructing a graphical representation of the process as a network comprising first nodes, representing decision points, second nodes representing primary stakeholders and actions providing direct input to decision making points, and leaves representing secondary stakeholders providing indirect input to decision making points; and
applying at least one analytic approach for evaluating the decision points of the graphical representation of the process.

19. The device of claim 18 wherein the method further comprises comparing results of said evaluating to at least one threshold for at least one predefined metric.

20. The device of claim 19 further comprising the steps of:
when the results have a first predetermined relationship to the at least one threshold for at least one predefined metric,
determining that the graphical representation of the process illustrates the optimal process;
when said results have a second predetermined relationship to the at least one threshold for at least one predefined metric,
updating the graphical representation to produce an updated graphical representation;
applying at least one analytic approach for evaluating the decision points of the updated graphical representation; and
comparing results of said evaluating of the updated graphical representation to at least one threshold for at least one predefined metric, whereby the graphical representation of the process illustrates the optimal process when the results have a first predetermined relationship to the at least one threshold for at least one predefined metric.
